(19) United States
(12) Patent Application Publication
(10) Pub. No.: US 2003/0131356 A1
(43) Pub. Date: Jul. 10, 2003

(54) METHOD AND APPARATUS FOR NOTIFICATION ON A BROADCAST DEVICE

(76) Inventors: ANDREW M. PROEHL, NEW YORK, NY (US); FRANKLIN SERVAN-SCHREIBER, NEW YORK, NY (US); KIM MINGO, BROOKLYN, NY (US)

Correspondence Address: BLAKELY SOKOLOFF TAYLOR & ZAFMAN, 12400 WILSHIRE BOULEVARD 7TH FLOOR, LOS ANGELES, CA, 90025

(21) Appl. No.: 09/218,119

(22) Filed: Dec. 21, 1998

(51) Int. Cl. H04N 7/025; H04N 7/10; G06F 3/00; H04N 5/445; G06F 13/00

(52) U.S. Cl. 725/58; 725/34

(57) ABSTRACT

A system and method for alerting a viewer of a broadcast of a program. In one embodiment, prior to broadcast, a signal is received indicating viewer interest in the program. The system retrieves program information for the program of interest and stores the program information in a calendar at the day/time of broadcast. Approximately when the day/time of broadcast occurs, the system issues a notification to the viewer of the occurrence of the broadcast.

### BACKGROUND OF THE INVENTION

1. Field of the Invention

The present invention relates to notification on a device such as a satellite system, television or a digital television.

2. Art Background

Many broadcasters advertise upcoming programs on their stations. Although a viewer may be interested in a particular program advertised, it is common to not remember the program at the time of airing.

### SUMMARY OF THE INVENTION

The system and method of the present invention enables the viewer to designate programs that he is interested in at the time it is advertised. Subsequently, when the broadcast of the identified program is about to air, a reminder notification is sent out to remind the viewer about the broadcast. The viewer can then select the program to view.

### BRIEF DESCRIPTION OF THE DRAWINGS

The objects, features, and advantages of the present invention will be apparent to one skilled in the art from the following detailed description in which:

FIG. 1 is a simple illustration of one embodiment of the present invention.

FIG. 2 is a block diagram representation of the elements utilized in the receiver in one embodiment of the present invention.

FIG. 3 is a representation of a remote control utilized to tune to television stations in accordance with the teachings of the present invention.

FIG. 4 illustrates the type of data utilized to present the electronic program guide in accordance with the teachings of the present invention.

FIG. 5 is a simplified block diagram of one embodiment of the system of the present invention.

FIG. 6 is a simplified flow diagram illustrating one embodiment of the method of the present invention.

FIG. 7 is a flow diagram illustrating an alternate embodiment of one method of the present invention.

FIGS. 8, 9, 10 and 11 illustrate displays generated in one embodiment in accordance with the teachings of the present invention.

### DETAILED DESCRIPTION

In the method and apparatus of the present invention the broadcast system described is a direct broadcast satellite system. However, it is readily apparent to one skilled in the art that other broadcast systems and format including digital televisions, high definition televisions, video systems and computer systems, which have the capability processing broadcast signals, may utilize the method and apparatus of the present invention. Furthermore, in the following description, for purposes of explanation, numerous details are set forth, such as menus, flowcharts and system configurations, in order to provide a thorough understanding of the present invention. However, it will be apparent to one skilled in the art that these specific details are not required in order to practice the present invention. In other instances, well known electrical structures and circuits are shown in block diagram form in order not to unnecessarily obscure the present invention.

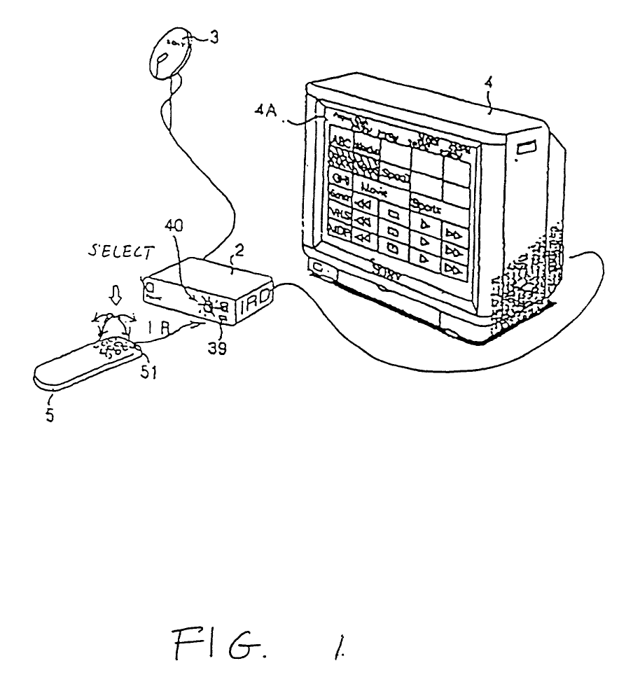

FIG. 1 is a simplified diagram illustrating a Direct Satellite System (DSS). The system has an antenna 3, an integrated receiver/decoder 2 (IRD), also referred to as a set top box, a remote controller 5, and a monitor 4. Packets of data are transmitted by a transponder on the satellite. Each transponder transmits data in a time share manner at a predetermined frequency. A tuner 21 of a decoder is tuned in to the frequency of the transponder corresponding to a channel, which is designated by a viewer so that the packets of digital data are received by the decoder.

The antenna 3 receives an encoded data signal sent from a satellite. The received encoded signal is decoded by the IRD. The antenna 3 has a low noise block down converter 3a (LNB). The LNB 3a converts a frequency of a signal sent from the satellite to another frequency. The converted signal is supplied to the IRD 3. The monitor 4 receives a signal from the IRD 3.

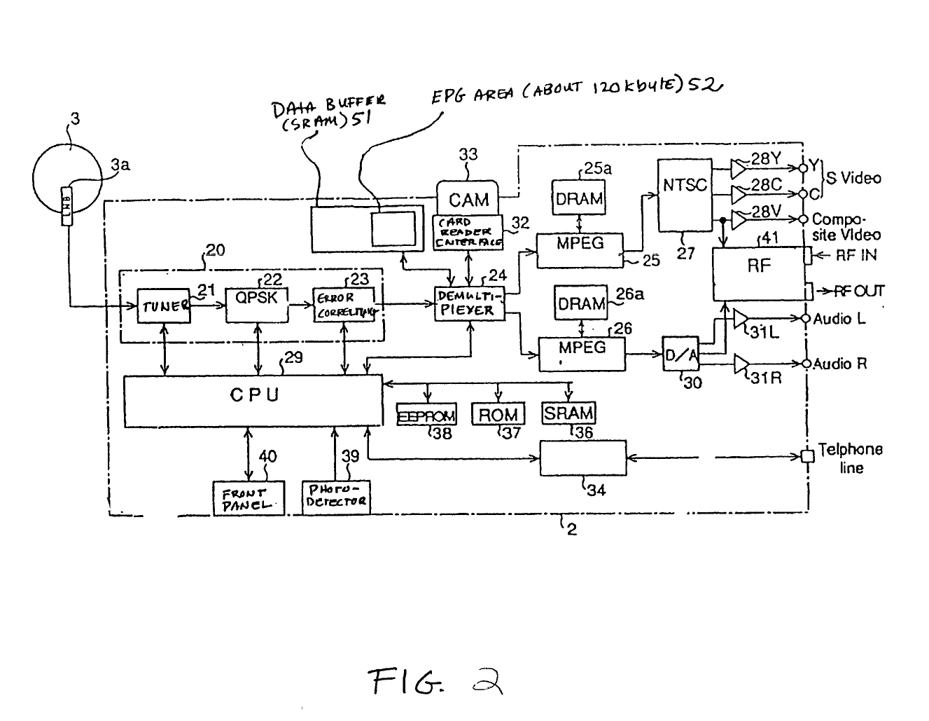

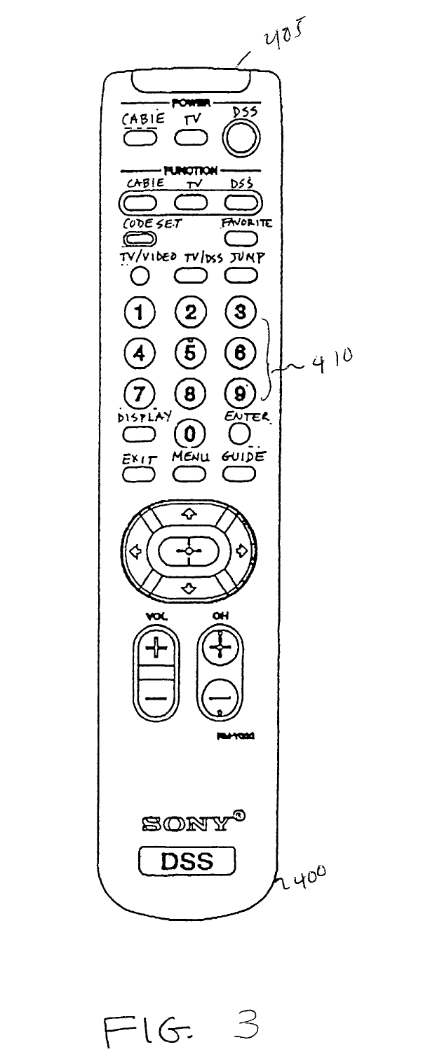

FIG. 2 is a block diagram of the IRD 3. A radio frequency (RF) signal output from the LNB 3a of the antenna 3 is supplied to a tuner 21 of a front end 20. The output from the tuner 21 is supplied to a quadrature phase shift keying (QPSK) demodulation circuit 22 for demodulation. The output from the QPSK demodulation circuit 22 is supplied to an error correcting circuit 23 for error correction. The data is received in encrypted and encoded (i.e., compressed) form.

The transport IC 24 receives the data stream, consisting of packets of data, from the error correcting circuit 23 and directs portions of the data stream to the appropriate circuit for processing. The digital data stream sent from a satellite includes headers for classifying the different portions of the data in the digital data stream. The transport IC stores the headers in registers and uses the headers to direct the data. The data stream sent from the satellite, includes video data in the format specified by the Motion Pictures Expert Group standard (MPEG), MPEG audio data and electronic programming guide (EPG) data. Data that is identified by its header to be video data is transferred to MFEG video decoder 25. Data that is identified by its header to be audio data is transferred to MPEG audio decoder 26. Similarly, data having a header that identifies the data to be EPG data is transferred to a predetermined area in the data buffer 51 designated to store the EPG.

A conditional access module 33, includes a central processing unit (CPU), a read-only memory (ROM) and a random access memory (RAM). The conditional access module determines whether the user has the authorization to receive certain data, e.g., audio/video for a pay TV station, using the authorization information stored in its memory. Thus, if the conditional access module determines that the user is authorized access, a key to decrypt the incoming data is provided to the transport IC 24, which decrypts the data using the key provided. In one embodiment, a smart card is utilized. This card is inserted into the card reader interface 32 for interface to the transport IC 24. It is readily apparent to one skilled in the art that the conditional access module is not limited to smart cards and may be configured in other kinds of circuitry.

The MPEG video decoder 25 decodes the video signal received from the transport IC. Dynamic random access memory (DRAM) 25a, connected to the MPEG video decoder 25, is used for buffering and storage of video data during processing by the MPEG video decoder. The decoded digital video signal is supplied to a National Television System Committee (NTSC) encoder 27 and converted to a Luminance signal (Y) and a chroma signal (C) which are respectively output through a buffer amplifier 28Y or 28C as an S video signal. A composite video signal is also output through a buffer amplifier 28V.

The MPEG audio decoder 26 decodes the digital audio signal. DRAM 26a, connected to the MPEG audio decoder 26, is used for buffering of data and information during processing by the MPEG audio decoder 26. The decoded digital audio signal is converted into an analog audio signal by D/A converter 30. The left audio signal is output through buffer amplifier 31L and the right audio signal is output through buffer amplifier 31R.

An RF modulator 41 mixes a composite signal output from the NTSC encoder 27 with an analog audio signal output from the D/A converter 30. The RF modulator 41 converts the mixed signal into an RF signal and outputs the RF signal therefrom.

The CPU 29 is the central control mechanism and executes code stored in the ROM 37 to perform certain functions of the system. For example, the CPU processes certain data to control the viewer notification mechanism accordance with the teachings of the present invention. In addition, the CPU receives and processes the user input, received from the front panel buttons or switches 40 and the photodetector circuit 39 to provide the user functionality and access to the system described herein. In addition, the CPU accesses user settings/preferences for processing of information and configuration of the system. The user settings are stored in the non-volatile memory, such as electrically erasable programmable read-only memory (EEPROM) 38. In addition, the CPU maintains a list of pointers, stored in static random access memory (SRAM) 36, to the channel information and program information stored in the SRAM 51. Thus, when a user wishes to display a form of the EPG on the screen or selects to be subsequently notified of a broadcast, the CPU 29, accessing pointers stored in the SRAM 36, communicates to the transport IC 34 to retrieve the data from the data buffer (SRAM) 51 identified by the pointers. The CPU then formulates the format and other digital data which forms the guide or list on the screen and forwards the data representative of the guide/list to the transport IC 34 which forwards the data to the DRAM 25a of the MPEG video decoder 25 for subsequent output to the screen. Alternately, the CPU uses the retrieved data to generated timely notifications of selected broadcasts in accordance with the teachings of the present invention.

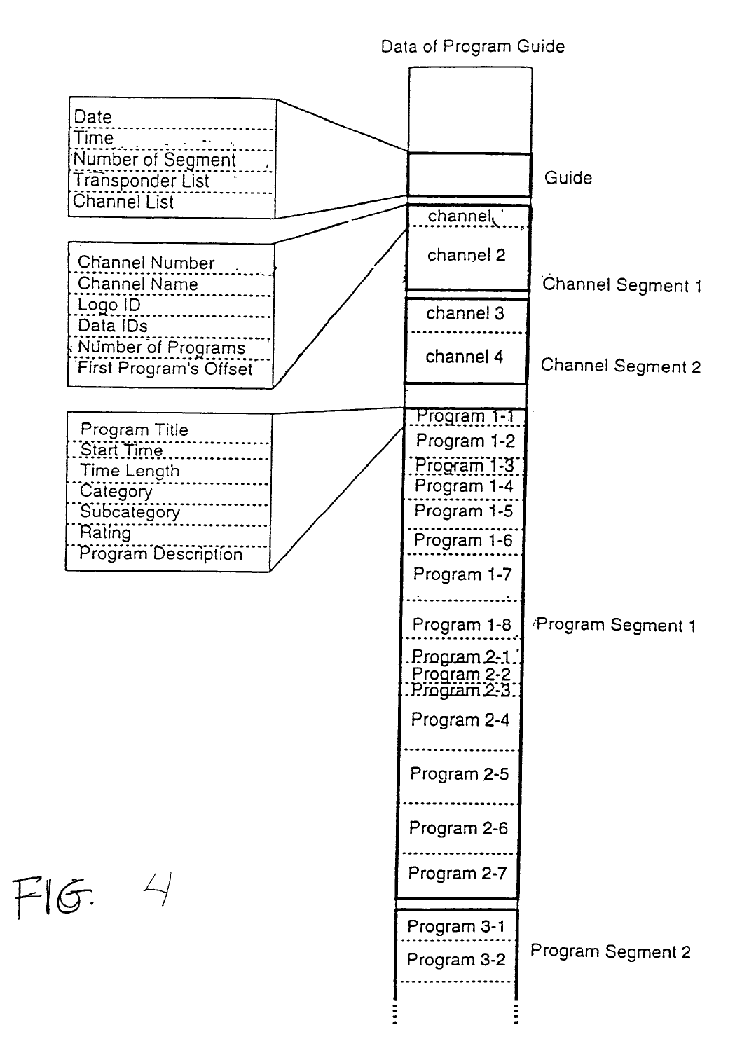

FIG. 4 shows an example of a remote controller utilized by a user to transmit commands and make program selections in accordance with the teachings of the present invention. The remote controller 400 has an infrared originating device 405, a set of operation buttons 410, a CPU, a ROM and a RAM (not shown). The CPU receives a signal sent from an operation button 410 through an input port 430. The signal is processed according to a program stored in the ROM. The RAM is used as a working space so as to produce a transmitting code. The transmitting code is sent to the infrared originating device through an output port and converted into an infrared signal. The infrared signal is transmitted to the IRD. The operation buttons 410 include a direction key for designating a pointer direction such as north, south, east and west, an “EPG” key, a “FAVORITE” key, a “SELECT KEY”, a “MENU” key, an “EXIT” key, a ten-key numeric keypad and an “ENTER” key.

FIG. 4 is a block diagram illustration of the data stored in a portion of the data buffer RAM 51. As noted above, the RAM 51 stores EPG data including guide data, channel data, and program data. General information is included in the guide data, for example, the current date and time. The transponder list identifies the number of the transponder transmitting a segment. The channel list identifies the channel number of the first channel of a portion of data. The channel data includes data relating to channels, such as the channel number, channel name (i.e., the call sign of a broadcast station), logo ID (i.e., an identification of the channel logo), data ID, which is an identification of a channel number of MPEG video data or MPEG audio data, number of programs, which identifies the number of programs to be transmitted on a channel during a predetermined time frame, and first program offset which identifies the offset from the header to the first channel data in a segment.

The program data includes the program title, start time of the program, time length of the program, program category such as movies, news, sports, etc., program subcategory such as drama, horror, children's movies or baseball, basketball, football for the sports category, the movie rating and program description that provides a detailed description of the program.

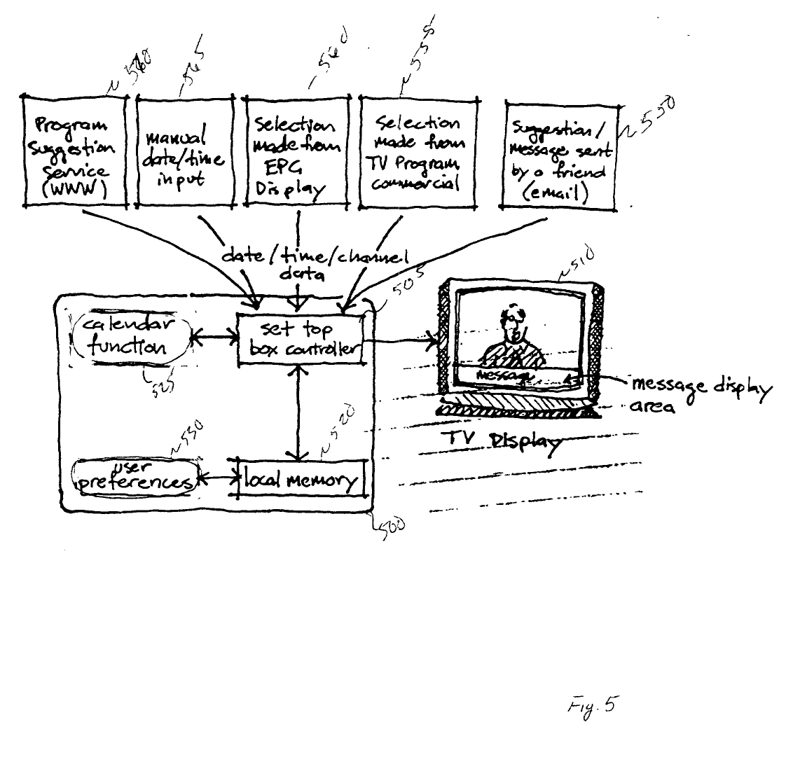

A simplified block diagram of one embodiment of the system of the present invention is illustrated in FIG. 5. The present embodiment illustrates a system which includes a set top box controller 505 which controls a television display 510. It is readily apparent that the system is not limited to set top boxes and televisions; rather, the system also can be embodied in other types of processor systems including a computing system that controls a display.

Referring back to FIG. 5, the system 500 includes the set top box controller 505, memory 520. The set top box controller 505 controls the display of information such as broadcasts received from satellite transmissions and associated data. In addition, the controller 505 preferably includes a calendar function 525 that operates in accordance with the teachings of the present invention. In one embodiment the calendar function may be implemented by a separate logic or processor.

Memory 520 stores incoming data, such as electronic programming guide data, as well as user preferences 530, including indications when a viewer expresses interest in viewing a particular program in the future. The set top box controller 505 can be configured to include a variety of functions known to those skilled in the art in addition to those functions described herein. For example, the controller 505 can perform email functions 550. Furthermore, in accordance with the teachings of the present invention, the controller 505 can be configured to make selections from future programs to watch from a television commercial 555, or from an EPG 560. The controller 505 is also configured to operate in accordance with the date/time input 565 and the coupled broadcast system 570.

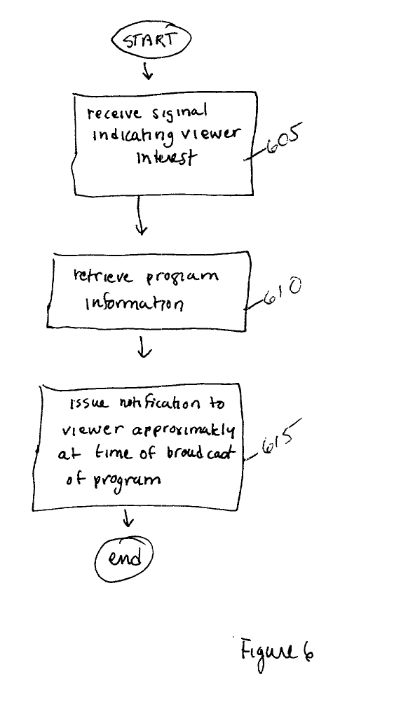

A simplified flow diagram of one embodiment of the method of the present invention is illustrated in FIG. 6. At step 605, a signal is received indicating viewer interest in a particular program that occurs in the future. As will be explained below, in one embodiment this step may occur in response to a broadcast of an advertisement for an upcoming program. The system responds to the signal received by retrieving program information regarding that program, including the start time, and the channel. The link between a received signal and corresponding program information may be realized a variety or ways. For example, the signal may include a program identification, e.g., title or other code that is used to reference into a database of program information. The database of program information may be data previously downloaded from broadcast or other sources. The program identification may be determined also by pattern as character recognition of the signal or portion of the signal, e.g., header or trailer, received.

Preferably, program information is stored in memory and linked to a calendar process that monitors the current date and time, and a notification that might be required at a particular date and time. Thus, at step 610, the system issues a notification to the viewer approximately at the time of broadcast of the program the viewer had previously expressed an interest in viewing, step 615. Preferably, the user is then able to respond to the program notification to select or not select to view that particular program.

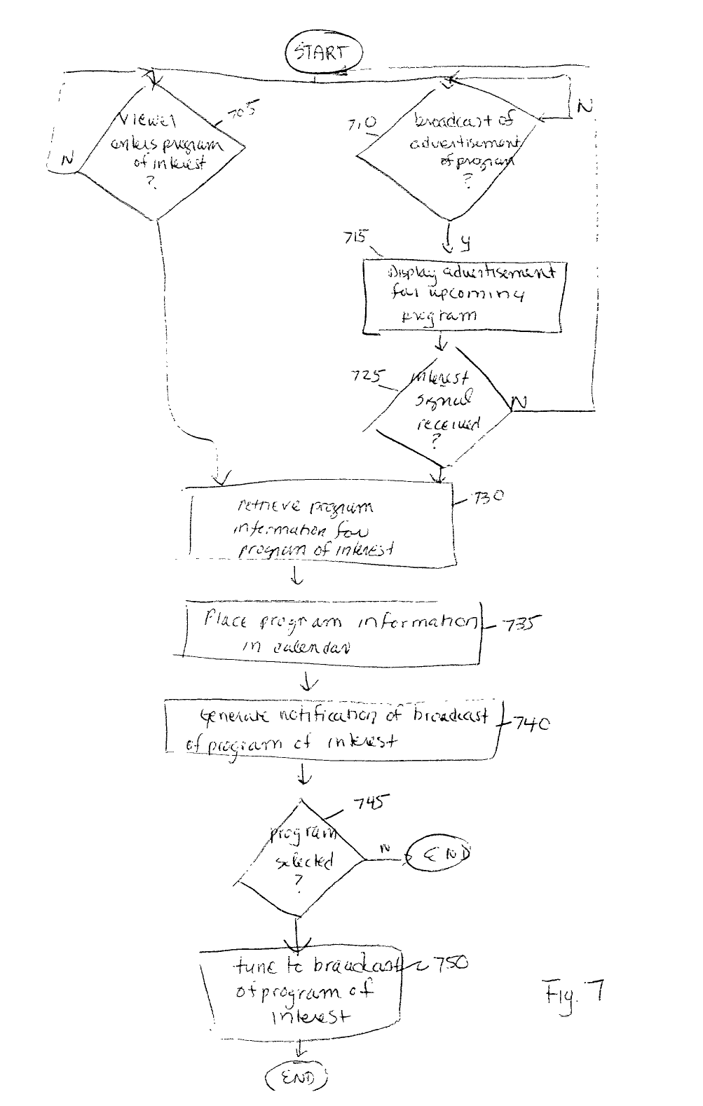

A variety of embodiments are contemplated. FIG. 7 illustrates one alternate embodiment. In this embodiment, the viewer is provided two methods for indicating a future program of interest for which notification is desired. At step 705, the viewer can enter into the system through a user input means, such as a cursor control device and a EPG display or a keyboard or touchpad mechanism, a particular program of interest, step 705. Alternately, if a program is advertised, step 710, the system displays the advertisement, step 715, for the upcoming program and enables the user to select at that time the program of interest. In one embodiment, this may be provided by generating a superimposed window over the program advertisement to ask the user if he wishes to be reminded of the program when it occurs. Alternately, the user may simply depress a particular button on his remote to indicate interest in the advertised program. A menu may be presented enabling the user to specify options regarding the selection, for example, whether to automatically tune to the program when it airs and/or record the program.

When the interest signal is received, step 720, indicating interest in the program, at step 725, the program information is retrieved and an entry is put in the system calendar to remind the user of the occurrence of the broadcast or the program, step 735. Thus, when the time of broadcast of a particular program occurs, notification of the broadcast of the program of interest is generated, step 740. The user selects to view the program, step 745, the system response by tuning to the broadcast of the program of interest, step 750.

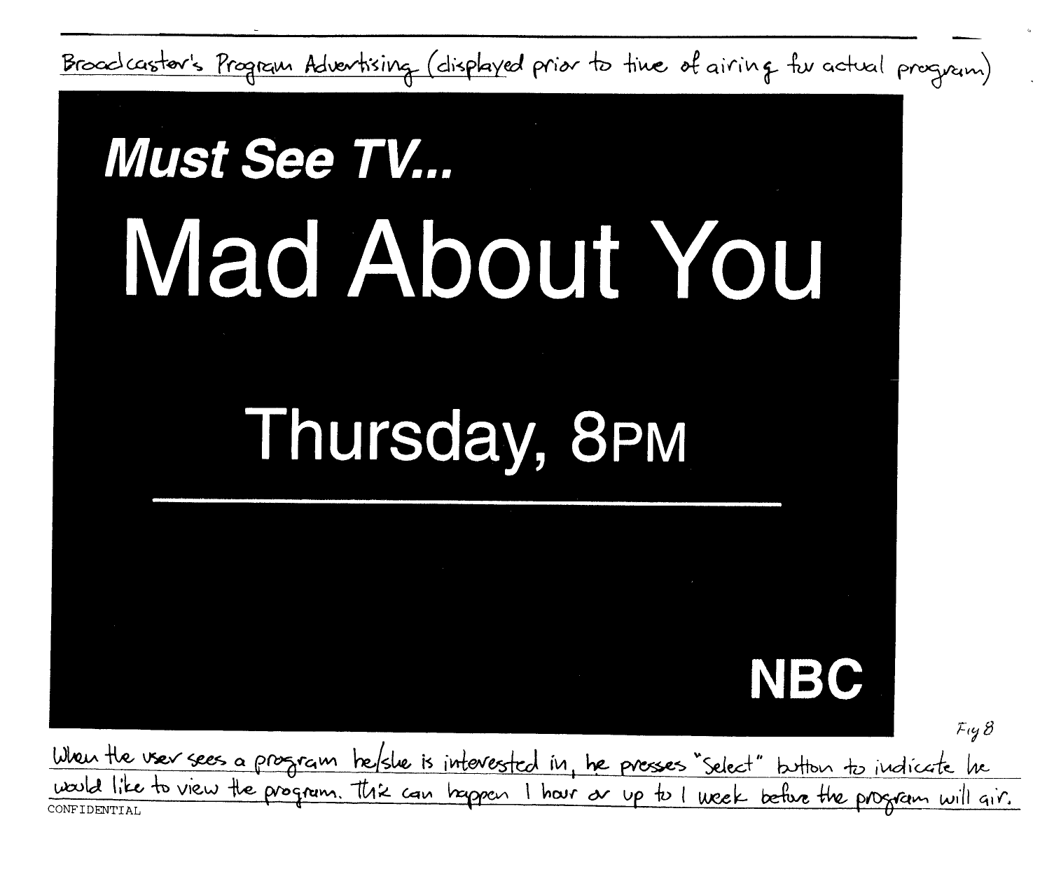

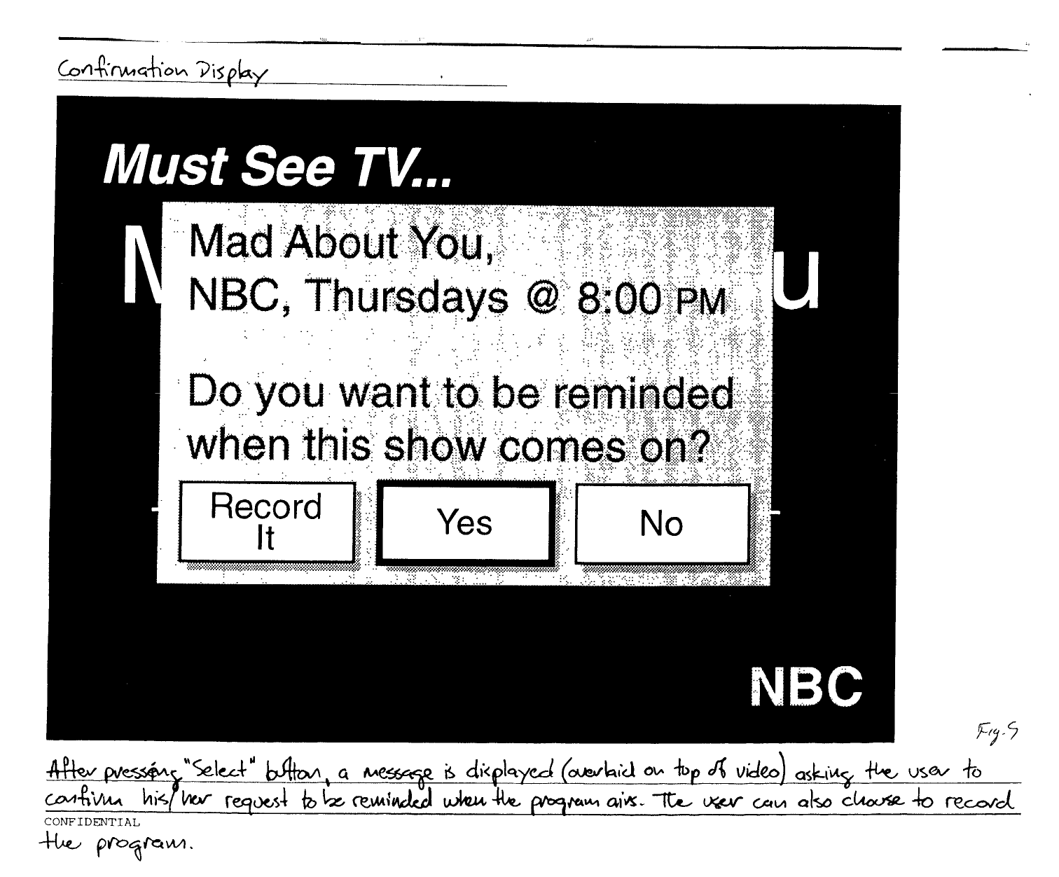

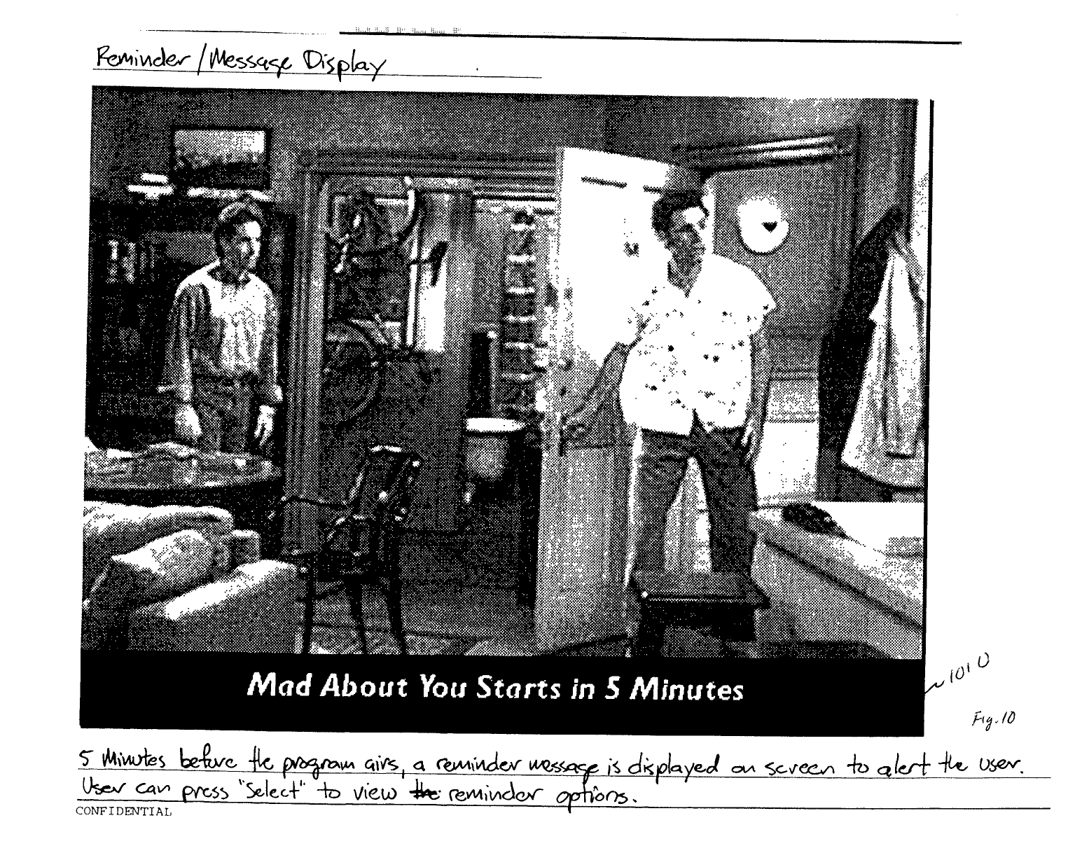

The advantages to using this process can be seen by referencing FIGS. 8, 9, 10 and 11. FIG. 8 is representative of an airing of an advertisement for an upcoming television program broadcast. In one embodiment, the user can depress the “select” button on his remote control to select the program for later viewing and/or recording when the advertised program subsequently airs.

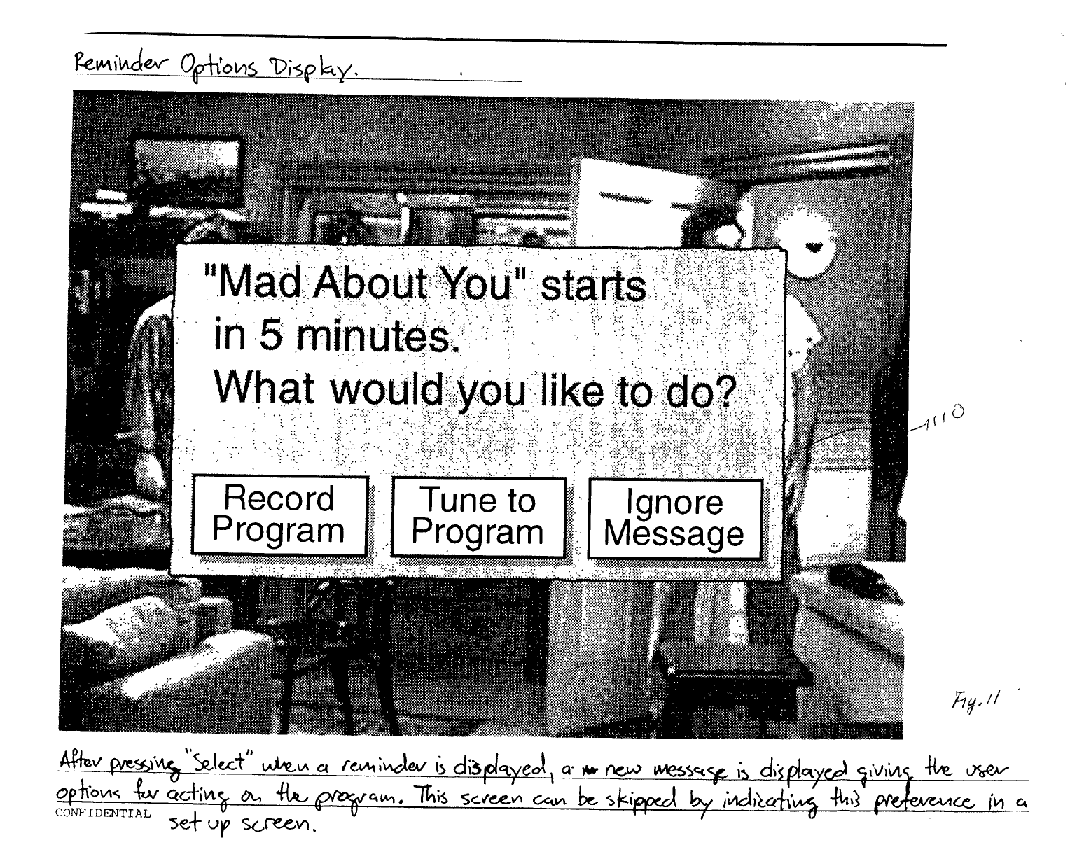

According to one embodiment of the process of the present invention, a message is displayed in response to the depression of the select button asking the user if he wishes to be reminded when the show is broadcast. In this embodiment, the user is also given an option to record the program. In the present embodiment, approximately five minutes before the program airs, a reminder message is displayed 1010 on the display to alert the user of the upcoming broadcast. At this point, the user can press a predetermined “select” button to view the program viewing options. A message is then displayed 1110, giving the user the opportunity to record the program, tune into the program or to remove the reminder notification message. Preferably, the system can be configured to have preferences such that these specific messages issued are tailored to the particular user. For example, for a user who never wishes to record programs, the record program option is not provided. Similarly, if the user, upon receiving the notification, wishes always to tune into the program, the system, instead of providing the message on FIG. 11 would simply tune to the particular program of interest.

Preferably the calendar is configured to enable a user to view the calendar of programs of interest, and also enable the viewer to edit the calendar. For example, if the user wishes to remove a particular program from the calendar, the system will provide a way for the viewer to delete the entry. Similarly, it is contemplated that a friend or family member may access the calendar to recommend programs to a particular user.

The calendar and notification functions described herein may be expanded to notify the viewer of other events, for example, news alerts, email status alerts (e.g., arrival of emails), paging alerts and household alerts such as messages that would appear when the door bell rings or an alarm system is triggered.

The invention has been described in conjunction with the preferred embodiment. It is apparent that numerous alternatives, modifications, variations and uses will be apparent to one skilled in the art in light of the foregoing description.

What is claimed is:

1. A method for alerting a viewer of a program, said method comprising the steps of:
receiving a signal indicating viewer interest in a program;
retrieving program information in response to the received signal; and
at approximately time of broadcast of the program, issuing a notification to notify the viewer of the broadcast of the program.

2. The method as set forth in claim 1, further comprising the step of switching a broadcast receiver to tune to the program when the viewer selects to view the program in response to the notification.

3. The method as set forth in claim 1, wherein the step of issuing a notification comprises the step of displaying on a viewing device the notification.

4. The method as set forth in claim 1, wherein the step of issuing a notification comprises the step of issuing a notification that includes a program selector to enable the viewer to select to view the program.

5. The method as set forth in claim 4, wherein the program selector comprises a button.

6. The method as set forth in claim 3, wherein the notification includes a button enabling the viewer to select to view the program, said method further comprising the step of switching a broadcast receiver to tune to the program when the viewer selects the button.

7. The method as set forth in claim 1, wherein the time at which the notification is issued is derived from program information retrieved.

8. The method as set forth in claim 1, further comprising the step of:
generating a second notification during a broadcast of a program advertisement, said second notification asking the viewer whether the viewer has interest in the program;
wherein said signal indicating viewer interest is generated by the viewer responding to the second notification.

9. The method as set forth in claim 1, wherein a view indicates interest by selecting a program from an electronic program guide.

10. The method as set forth in claim 1, further comprising the step of generating a calendar of at least one program of interest.

11. A method for alerting a viewer of a program, said method comprising the steps of:
issuing a first notification during a broadcast of an advertisement of an upcoming program, said first notification asking a viewer whether the viewer has interest in the program;
receiving a signal indicating viewer interest in a program;
retrieving program information in response to the received signal; and
at approximately time of broadcast of the program, issuing a second notification to notify the viewer of the broadcast of the program.

12. The method as set forth in claim 11, further comprising the step of switching a broadcast receiver to tune to the program when the viewer selects to view the program in response to the second notification.

13. The method as set forth in claim 11, wherein the step of issuing a notification comprises the step of displaying on a viewing device the second notification.

14. The method as set forth in claim 11, wherein the step of issuing a second notification comprises the step of issuing the second notification that includes a program selector to enable the viewer to select to view the program.

15. The method as set forth in claim 14, wherein the program selector comprises a button.

16. The method as set forth in claim 13, wherein the second notification includes a button enabling the viewer to select to view the program, said method further comprising the step of switching a broadcast receiver to tune to the program when the viewer selects the button.

17. The method as set forth in claim 11, wherein the time at which the second notification is issued is derived from program information retrieved.

18. The method as set forth in claim 1, wherein the first notification includes a button enabling the viewer to indicate interest.

19. An apparatus comprising:
a first receiver configured to receive broadcast signals;
a second receiver configured to receive at least one control signal, said control signal issued to indicate viewer interest in a program to be broadcast;
a controller coupled to the first receiver and second receiver, said controller configured to retrieve program information in response to receipt of the control signal and issue, at approximately a time of broadcast, a notification to the viewer of the broadcast of the program.

20. The apparatus as set forth in claim 19, wherein the controller is further configured to generate a second notification asking the viewer whether the viewer has interest in the program.

21. The apparatus as set forth in claim 20, wherein the second notification is generated during broadcast of an advertisement of the program.

22. The apparatus as set forth in claim 21, wherein the second notification comprises a notification window superposed over the advertisement broadcast.

23. The apparatus as set forth in claim 20, wherein the viewer indicates interest in the program by selection of a button located in the notification window, wherein the control signal is generated in response to the viewer indicating interest.

24. The apparatus as set forth in claim 19, wherein the notification includes a button enabling the viewer to select to view the program, said controller further configured to control to switch a broadcast receiver to tune to the program when the viewer selects the button.

25. The apparatus as set forth in claim 19, wherein the second receiver is further configured to tune to the program when the viewer selects to view the program in response to the notification.

26. The apparatus as set forth in claim 19, further comprising a viewing device, said notification displayed on the viewing device.

27. The apparatus as set forth in claim 19, wherein the notification comprises further comprises a program selector to enable the viewer to select to view the program.

28. The apparatus as set forth in claim 27, wherein the program selector comprises a button.

29. The apparatus as set forth in claim 26, wherein the notification includes a button enabling the viewer to select to view the program, second receiver tuning to the program when the viewer selects the button.

30. The apparatus as set forth in claim 27, wherein the time at which the notification is issued is derived from program information retrieved.

31. The apparatus as set forth in claim 19, further comprising an electronic program guide, said user interest indicated by reference to the electronic program guide.

32. The apparatus as set forth in claim 19, further comprising a calendar identifying at least one program of interest to the viewer.

33. A computer readable medium containing executable instructions which, when excluded in a processing system, causes the system to perform steps for alerting a viewer of a program comprising:
receiving a signal indicating viewer interest in a program;
retrieving program information in response to the received signal; and
at approximately time of broadcast of the program, issuing a notification to notify the viewer of the broadcast of the program.

34. The computer readable medium as set forth in claim 33, further comprising instructions which, when executed, switch a broadcast receiver to tune to the program when the viewer selects to view the program in response to the notification.

35. The computer readable medium as set forth in claim 33 further comprising instructions, which when executed perform steps comprising:
generating a second notification during a broadcast of a program advertisement, said second notification asking the viewer whether the viewer has interest in the program;
wherein said signal indicating viewer interest is generated by the viewer responding to the second notification.

36. A computer readable medium containing executable instructions which, when executed in a processing system caused the system to perform steps for alerting a viewer of a program comprising:
issuing a first notification during a broadcast of an advertisement of an upcoming program, said first notification asking a viewer whether the viewer has interest in the program;
receiving a signal indicating viewer interest in a program;
retrieving program information in response to the received signal; and
at approximately time of broadcast of the program, issuing a second notification to notify the viewer of the broadcast of the program.

37. The computer readable medium set forth in claim 36, further comprising instructions, which when executed, switch a broadcast receiver to tune to the program when the viewer selects to view the program in response to the second notification.
